(19) United States
(12) Patent Application Publication
(10) Pub. No.: US 2019/0119004 A1
(43) Pub. Date: Apr. 25, 2019

(54) Scarecrow Trash Bag

(71) Applicant: Keaney Productions LLC, Pittsburgh, PA (US)

(72) Inventor: Kenneth James KEANEY, Pittsburgh, PA (US)

(73) Assignee: Keaney Productions LLC, Pittsburgh, PA (US)

(21) Appl. No.: 16/166,685

(22) Filed: Oct. 22, 2018

Related U.S. Application Data
(60) Provisional application No. 62/575,479, filed on Oct. 22, 2017.

(51) Int. Cl. B65D 33/00; B65D 65/46; B65F 1/00; B65D 33/16; B65D 33/28; B65D 33/25

(52) U.S. Cl. CPC B65D 33/004; B65D 65/466; B65F 1/002; B65F 2240/156; B65D 33/28; B65D 33/25; B65F 2240/138; B65D 33/1608

(57) ABSTRACT

A human shaped refuse bag for filling with material and using as a holiday display is provided. The Scarecrow Trash Bag can be various sizes and shapes. The bag is seamed to have one or more openings for receipt of filling material. The bags can be made out of various materials, and the completed bags then can have various printed characters on them. Some examples of such characters include: Scarecrow, Skeleton, Pumpkin, Monster, and Mummy. The likeness of other fictional and nonfictional characters could also be printed on the bags. This product is differentiated from all others by its shape and media platform. The product is best suited for the fall season and the Halloween holiday.

### CROSS-REFERENCE TO RELATED PATENT APPLICATIONS

This Patent Application claims the benefit of and priority to U.S. Provisional Patent Application Ser. No. 62/575,479 filed Oct. 22, 2017, entitled “SCARECROW BAG”, which is hereby incorporated by reference in its entirety.

### BACKGROUND OF THE INVENTION

The application generally relates to a shaped bag suitable for holiday display. The application relates more specifically to a leaf or trash bag having seasonal fall, holiday, or festive indicia which are of human form and suitable for receiving filler material (e.g. leaves, straw, paper, etc.).

During certain times of the year, holiday, seasonal, and festive decorative objects are very popular. In the fall, around the time of the Halloween holiday, common decorative objects have the image of a skeleton or scarecrow. In certain geographic locations during the fall season, leaves are on the ground, and homeowners often rake their leaves and dispose of them in relatively large leaf bags. Except for a new type of leaf bag (the details of which are disclosed in the related application hereto, Ser. No. 07/554,967) which has been sold during the Halloween season to represent or simulate a pumpkin, the known leaf bags are ordinary leaf bags with no particular significance and with no particular decorative value. In addition, except for the bags disclosed in the related applications hereto, garbage or refuse bags are typically not decorative or theme-related. None of these bags more specifically include decorative human forms upon them. The bags would not require a printed imagery as they can themselves be decorated with Halloween costumes or average day-to-day clothes.

What is needed is a system and/or method that provides various shapes and graphical representation on a hollow fillable trash bag in the shape of a character. Other features and advantages will be made apparent from the present specification. The teachings disclosed extend to those embodiments that fall within the scope of the claims, regardless of whether they accomplish one or more of the aforementioned needs.

### SUMMARY OF THE INVENTION

A first embodiment of the present invention relates to a unique bag shaped in the human form for filling with material. The bag is formed from a first sheet of material and a second sheet of material which are joined along the periphery by a seam which extends around the periphery to form a bag shape with an opening at one end. This opening is for receipt of the filling material. The first and second sheets of material that form the bag can be made from any variety of materials including a biodegradable or a renewable material. A closure element such as a tieable drawstring, a multiplicity of flaps, a zip-tie, or a twist-tie is incorporated into the structure of the opening or provided with the bag to secure the filling material within the bag.

Another embodiment of the present invention relates to a unique bag shaped in the human form for filling with material. The bag is formed from a first sheet of material and a second sheet of material which are joined along the periphery by a seam which extends around the periphery to form a bag shape with an opening at one end. This opening is for receipt of the filling material. A closure element such as a tieable drawstring, a multiplicity of flaps, a zip-tie, or a twist-tie is incorporated into the structure of the opening or provided with the bag to secure the filling material within the bag. Character indicia is then fixed to a surface of the bag. The character indicia can fixed to a surface of the bag by any variety of processes including, but not limited to, drawing, painting, or printing. These character indicia can be placed on either the front or back of the bag, or both sides, and incorporate a wide array of characters. For example, the character indicia could represent a Scarecrow, a Skeleton, a Pumpkin, a Monster, and a Mummy.

Yet another embodiment of the present invention relates to a variably shaped version of the Scarecrow Trash Bag as described above. In this embodiment, the size and stature of the bag is altered in order to emulate any of a variety of human-proportioned figures. For example, the bag can be altered to display different weights, heights, ages, and sexes of human-proportioned figures.

Still another embodiment relates to a simple, seamed bag made of two sheets of material. In the preferred embodiment, the opening is at the top of the head of the bag. This is the only opening on the bag and allows for filling of the arms and legs, then the torso, and finally the head. Other embodiments of the bag can have an opening in a different location such as on one or both feet, on the back or front of the torso portion, or at the back or front of the neck portion. The opening is then tied off to close the bag and place for decoration.

Another embodiment relates to a simple, seamed bag made of an inelastic, thin, flexible plastic material, consistent with that used in leaf or trash bags. At least the major portion of the outside surface of each bag in the assembly is preferably provided with coloration relevant to the figure represented, the holiday or festival being celebrated, and/or the purpose or occasion served by the decoration. For example, the major portion of the skeleton scarecrow bag is preferably colored black, with white indicia on the outside surface of each bag indicating the bones of the skeleton.

It is therefore an advantage of the invention to provide a human shaped or human-proportioned vessel for filler material. In addition, when provided with appropriate indicia, the bags simulate a seasonal, festive, holiday, or non-holiday costumed figure.

It is a further advantage of the invention to provide a simple, easy-to-manufacture, easy-to-fill decoration with no assembly required. The filled bags can be erected indoors or outdoors as human-sized or human-proportioned figures. The blank bags or bags without imagery may be outfitted with clothing, masks, or costumes.

Still another advantage of the invention is that the bags will have opportunity for printed media or colored materials to simulate a character. The bags could then take the form of limitless humanoid figures.

Certain advantages of the embodiments described herein are the provision of an easy-to-display holiday decoration that can be set-up and taken down quickly while also providing a vessel to secure unwanted household refuse.

Alternative exemplary embodiments relate to other features and combinations of features as may be generally recited in the claims.

### BRIEF DESCRIPTION OF THE FIGURES

The application will become more fully understood from the following detailed description, taken in conjunction with the accompanying figures, wherein like reference numerals refer to like elements, in which:

FIG. 1 is a perspective view of an embodiment of the blank Scarecrow Trash Bag.

FIG. 2 is a perspective view of an embodiment of the skeleton Scarecrow Trash Bag.

FIG. 3 is a perspective view of an embodiment of the pumpkin Scarecrow Trash Bag.

FIG. 4 is a perspective view of an embodiment of the scarecrow Scarecrow Trash Bag.

FIG. 5 is a perspective view of an embodiment of the mummy Scarecrow Trash Bag.

Wherever possible, the same reference numbers will be used throughout the drawings to refer to the same or like parts.

### DETAILED DESCRIPTION OF THE EXEMPLARY EMBODIMENTS

Before turning to the figures which illustrate the exemplary embodiments in detail, it should be understood that the application is not limited to the details or methodology set forth in the following description or illustrated in the figures. It should also be understood that the phraseology and terminology employed herein is for the purpose of description only and should not be regarded as limiting.

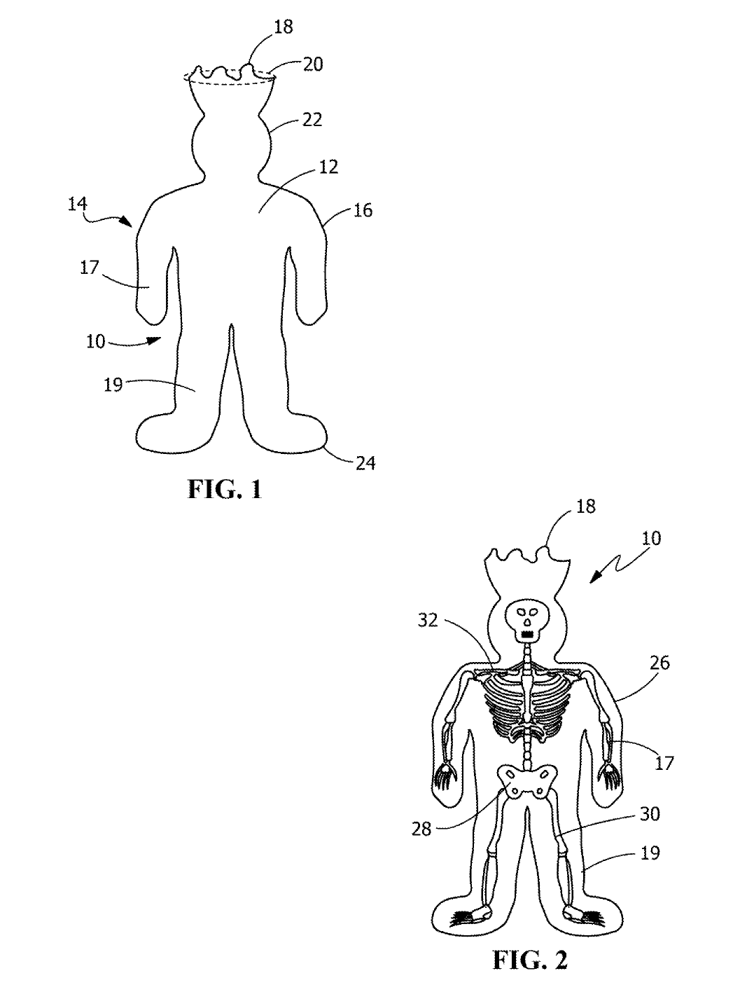

Referring to FIG. 1, a completed bag 10 consisting of a first sheet 12 and a second sheet 14 joined at a seam 16 as indicated by the thicker line in FIG. 1, with an aperture, or opening 18, at the top for filling, as denoted by the thinner, wavy line. Once filled, opening 18 may be tied, pinned or clipped shut by a closure element 20 indicated by the dotted line encircling the opening.

It is noted that the preferred embodiment includes one continuous seam 16 around the body of the figure and one opening 18 at the top of the seamed sheets 12, 14. This is the preferred design; however, the seams could be done differently based on folding of sheeting used in manufacturing. In addition, the opening 18 in which the bag is filled in the preferred embodiments may be located adjacent the head portion 22. Alternatively opening 18 may be located adjacent one or both of foot portions 24 or on the second, or rear, sheet 14 of bag 12. Finally, the size of bag 10 is also flexible. For example, the bags could be made of less material to depict children, or more material to depict a large humanoid creature or giant. In the exemplary embodiment, first sheet and second sheet include shapes with appendages representative of an outline a human figure. A pair of arms 17 and a pair of legs 19 are circumscribed by seam 16.

Referring to FIG. 2, a black bag 26 with white indicia 28 placed upon it to appear as a skeleton is depicted. Indicia is depicted on front 30 of bag 26 in FIG. 2, but indicia could also be placed on the back 32 of the bag 26. FIG. 2 is a simple example of the figures the bags can portray. Thus, while the skeleton bag has been disclosed, it will be appreciated that other seasonal, festive, holiday, and non-holiday figures can likewise be made from similar components having different indicia. For example, and not by way of limitation, a scarecrow, a clown, a jack o' lantern, a mummy, a vampire, monsters, famous people, movie and television characters, and anything else one could imagine. Also, while the figure has been disclosed to be human-sized and human-proportioned, it will be appreciated that the figure need not be both human-sized and human-proportioned.

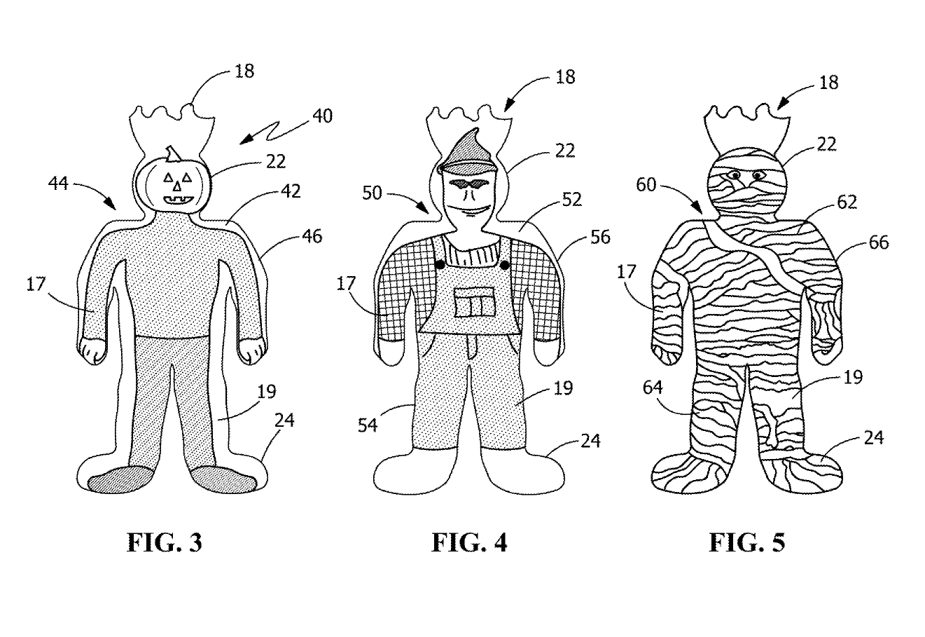

Referring to FIG. 3, a bag 40 with indicia 42 placed upon it to appear as a pumpkin-person is depicted. The indicia 42 is depicted on the front 44 of the bag 40 in FIG. 3, but indicia 42 could also be placed on the back 46 of the bag 40.

Referring to FIG. 4, a bag 50 with indicia 52 placed upon it to appear as a scarecrow is depicted. The indicia 52 is depicted on the front 54 of the bag 50 in FIG. 4, but indicia 52 could also be placed on the back 56 of the bag 50.

Referring to FIG. 5, a bag 60 with indicia 62 placed upon it to appear as a mummy is depicted. The indicia 62 is depicted on the front 64 of the bag 60 in FIG. 2, but indicia 62 could also be placed on the back of the bag 66.

While the exemplary embodiments illustrated in the figures and described herein are presently preferred, it should be understood that these embodiments are offered by way of example only. Accordingly, the present application is not limited to a particular embodiment, but extends to various modifications that nevertheless fall within the scope of the appended claims. The order or sequence of any processes or method steps may be varied or re-sequenced according to alternative embodiments.

It is important to note that the construction and arrangement of the Scarecrow Trash Bag as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present application. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangement of the exemplary embodiments without departing from the scope of the present application.

What is claimed is:

1. A unique bag shaped in the human form for filling with material, comprising:
a first sheet of material and a second sheet of material connectedly joined along a periphery of the bag with a seam that extends around substantially the entire periphery, and an opening at an end of the bag to form a hollow interior space for receipt of the filling material; and
a closure element attachable to the opening for retaining material within.

2. The unique bag of claim 1, wherein the first and second sheets of material are made from a biodegradable material.

3. The unique bag of claim 1, wherein the first and second sheets of material are made from a recyclable material.

4. The unique bag of claim 1, wherein the filling material to be used is yard clippings.

5. The unique bag of claim 1, wherein the filling material to be used is leaves.

6. The unique bag of claim 1, wherein the filling material to be used is newspaper.

7. The unique bag of claim 1, wherein the filling material to be used is straw.

8. The unique bag of claim 1, wherein the closure element is a tieable drawstring incorporated into the opening of the bag.

9. The unique bag of claim 1, wherein the closure element is a multiplicity of flaps capable of being tied together incorporated into the opening of the bag.

10. The unique bag of claim 1, wherein the closure element is a zip-tie included with the bag.

11. The unique bag of claim 1, wherein the closure element is a twist-tie included with the bag.

12. A unique bag shaped in human form for filling with material, comprising:
a first sheet of material and a second sheet of material connectedly joined along a periphery of the bag with a seam that extends around substantially the entire periphery;
an opening at an end of the bag to form a hollow interior space for receipt of the filling material;
a character indicia displayed on at least one of the first sheet and the second sheet of the bag; and
a closure element for the opening of the bag.

13. The unique bag of claim 12, wherein the character indicia is drawn on the surface of the bag.

14. The unique bag of claim 12, wherein the character indicia is printed on the surface of the bag.

15. The unique bag of claim 12, wherein the character indicia is painted on the surface of the bag.

16. A unique bag shaped in human form for filling with material, comprising:
a first sheet of material and a second sheet of material connectedly joined along a periphery of the bag with a seam that extends around substantially the entire periphery;
an opening at an end of the bag to form a hollow interior space for receipt of the filling material;
a character indicia displayed on at least one of the first sheet and the second sheet of the bag; and
a closure element for the opening of the bag,
wherein the bag is altered by size and stature in order to emulate any of a variety of human-proportioned figures.

17. The unique bag of claim 16, wherein the bag is altered to emulate different weights of human-proportioned figures.

18. The unique bag of claim 16, wherein the bag is altered to emulate different heights of human-proportioned figures.

19. The unique bag of claim 16, wherein the bag is altered to emulate different ages of human-proportioned figures.

20. The unique bag of claim 16, wherein the bag is altered to emulate different sexes of human-proportioned figures.
